(19) United States
(12) Patent Application Publication
(10) Pub. No.: US 2024/0278929 A1
(43) Pub. Date: Aug. 22, 2024

(54) ON-BOARD SYSTEM FOR DETECTING IMPACTS ON THE FUSELAGE OF AN AIRCRAFT

(71) Applicant: OTONOMY AVIATION, MERIGNAC (FR)

(72) Inventors: Maxime DANIELLI, BORDEAUX (FR); Guillaume DAUDON, BORDEAUX (FR)

(21) Appl. No.: 18/570,224

(22) PCT Filed: Jun. 13, 2022
(86) PCT No.: PCT/EP2022/066008

§ 371 Date: Dec. 14, 2023

(30) Foreign Application Priority Data
Jun. 14, 2021 (FR) 2106267

(51) Int. Cl. B64D 45/00; B64F 5/60; G01L 5/00

(52) U.S. Cl. CPC B64D 45/00; B64F 5/60; G01L 5/0052; B64D 2045/0085

(57) ABSTRACT

An on-board system for detecting impacts on the fuselage of an aircraft, comprising: a plurality of impact sensors arranged on a plurality of areas of the fuselage, each sensor being capable of detecting an impact on the fuselage at its position, a detection module for detecting a vehicle in the vicinity of the aircraft, the detection module being capable of estimating the speed of a detected vehicle, and a computer arranged, upon an impact on the fuselage being detected by an impact sensor, to record, in a memory of the on-board system, an item of information relating to the speed of a vehicle detected by the detection module.

The invention relates to the field of aeronautics. More specifically, the invention relates to the detection of impacts against the fuselage of an aircraft and the optimization of the operation of an aircraft on the ground.

When an aircraft is parked in an airport, in particular for passenger boarding or unboarding, transshipping baggage or freight, maintenance or re-fueling, a large number of vehicles are traveling around the aircraft and thus may come into contact with the fuselage of the aircraft, which could damage it.

The impacts thus caused must be detected, in order to be able to estimate whether repairing or maintaining the fuselage is necessary. In a known manner, this detection is carried out visually by one or more operators, which generates several drawbacks. On the one hand, an operator can not observe damage on the fuselage even though an impact of significant amplitude has taken place. On the other hand, given the dimensions of the fuselage, the inspection can have a significant duration and/or mobilize several operators. Finally, the aircraft must be immobilized on the ground throughout the duration of the inspection, which increases the duration of its unavailability and this therefore has an impact on the cost to the airline as well as on its flight schedules.

Finally, if an impact is detected and if the resulting fuselage damage requires repair or maintenance, it is necessary to be able to identify the vehicle responsible for this impact, in order to be able to send a report on this impact to its operator, and so that it can intervene as quickly as possible, and possibly charge it for the cost of this repair or maintenance.

There is thus a need for a system to reliably and rapidly detect an impact caused by a vehicle on the fuselage of an aircraft and to identify the vehicle responsible for this impact.

The present invention is in this context and aims to meet this need.

For these purposes, the invention relates to an on-board system for detecting impacts on the fuselage of an aircraft, comprising:
a. a plurality of impact sensors arranged on a plurality of areas of the fuselage, each sensor being able to detect an impact on the fuselage at its position,
b. a module for detecting a vehicle in the vicinity of the aircraft, the detection module being able to estimate the speed of a detected vehicle, and
c. a computer arranged to, when an impact on the fuselage is detected by an impact sensor, record information in a memory of the on-board system, relating to the speed of a vehicle detected by the detection module.

By virtue of the invention, the impact sensors on board the aircraft fuselage can detect an impact on this fuselage, in a virtually instantaneous and reliable manner, even when the damage caused by this impact is not visible to the naked eye. Furthermore, the addition of a detection module also on-board the aircraft makes it possible to identify the vehicles traveling around the aircraft, which are moving away from it and/or closer to it, and therefore to detect, also virtually instantaneously, the vehicle responsible for this impact. The estimation of its speed then makes it possible to determine its responsibility in this impact and optionally to qualify or to confirm the amplitude of the impact estimated by the impact sensors. In this way, an anomaly ratio can then be transmitted to the vehicle's operating company. Finally, it should be noted that the fact that the entire system is on-board the aircraft allows the airline to obtain in real time all of this information, without having to go through an external monitoring system managed by the operating company of the airport where that aircraft is parked.

Preferably, the computer is arranged to record in said memory, the position of said detected impact, estimated by means of an identifier of said impact sensor that detected an impact, the positions of each of the impact sensors on the fuselage being predetermined. Insofar as the entire fuselage is covered with a plurality of impact sensors, distributed in sufficient number on this fuselage, it is thus possible for the computer to identify in real time the position of an impact detected by a sensor, in order to minimize the detection and intervention time for maintenance and/or repair purposes.

Advantageously, the computer is arranged to, when an impact on the fuselage is detected by an impact sensor, trigger the detection of a vehicle in the vicinity of the aircraft by the detection module and the estimating of the speed of said detected vehicle. In other words, the detection of an impact by one of the impact sensors is what “wakes up” the detection module in order to identify the vehicle responsible for the impact and to estimate its speed. Thus, the power consumption of the system is optimized.

As a variant, the detection module can be arranged to continuously identify in real time all of the vehicles circulating around the aircraft, and the computer can be arranged to, when an impact on the fuselage is detected by an impact sensor, request the identification by the detection module of a vehicle in the vicinity of the position of said impact sensor that detected an impact, in particular at an instant preceding and/or following the detection of said impact.

Advantageously, each impact sensor is able to estimate the power of an impact that it detects and to transmit information relating to this power to the computer, the system being arranged to transmit an alarm signal intended for a remote electronic system if the estimated power of said impact is greater than a predetermined threshold. If necessary, the system can be provided with a wireless communication module able to transmit said alarm signal to said remote electronic system. According to this feature, it is thus possible to trigger an intervention for maintenance and/or repair operations in minimal time.

In one embodiment of the invention, each impact sensor is a piezoelectric sensor, of the piezoresistive or capacitive type.

According to another embodiment of the invention, each sensor comprises a sensing body; an electrically insulating substrate; a first electrode bonded to the substrate; a second electrode; a set of conductive or semi-conductive nanoparticles in contact with the two electrodes; a measurement device delivering information proportionate to an electrical property of the set of nanoparticles, which property is measured between the first and second electrodes, said electrical property being sensitive to the distance between the nanoparticles of the set. If necessary, the sensing body may be formed by the set of nanoparticles itself. This type of sensor advantageously makes it possible to quantify the force exerted by the vehicle on the fuselage, regardless of the shape of the fuselage in the location of the sensor. It is possible, for example, to refer to the content of patent application EP2601491, which describes an example of such a sensor using a set or assembly of nanoparticles.

According to the invention, an “assembly of nanoparticles” is made up of one or more sets of nanoparticles linked together by a ligand (or coordinate) within each set, said sets being linked together electrically. For example, the nanoparticles are gold nanoparticles. Again for example, the ligand may be a sodium citrate or an alkylamine.

“Proportional information” means a measurement which varies with the measured property, the proportionality function being able to be linear, exponential, or any other mathematical form establishing a one-to-one relationship between the value of the measurement and the value of the measured property. For example, the measured electrical property may be the resistance of the assembly of nanoparticles, or even the electrical capacity of the assembly of nanoparticles.

Advantageously, the second electrode is remote from the first electrode and can be movable relative to the substrate, and the assembly of nanoparticles can be placed between the two electrodes so that a movement of the second electrode causes a modification of the distance between the nanoparticles of said assembly of nanoparticles.

In one embodiment of the invention, the impact sensors are arranged on an exterior wall of the fuselage. The system can thus be installed on-board an aircraft already in service. Alternatively, the impact sensors will be arranged on an interior wall of the fuselage. Alternatively, some impact sensors will be arranged on an interior wall of the fuselage and other impact sensors will be arranged on an exterior wall of the fuselage.

Advantageously, each impact sensor may be attached to an adhesive tape bonded to the exterior wall of the fuselage. This embodiment makes it possible to install the system in a particularly simple and inexpensive manner. As a variant, each impact sensor may be integrated into a coating, in particular a layer of paint, applied to the exterior wall of the fuselage.

In one embodiment of the invention, each impact sensor is connected to a wireless transmission module capable of transmitting data relating to a detection performed by said impact sensor. If necessary, the computer comprises a wireless reception module for receiving said data. This avoids the use of wiring external to the aircraft in order to connect the impact sensors to the computer.

According to one example, the on-board system comprises a plurality of wireless transmission modules, each associated with a group of impact sensors to receive the detection data transmitted by each of the impact sensors of this group. The cost of the on-board system is thus minimized.

Advantageously, each transmission module comprises an antenna having a maximum transmission power less than 15 dB, or even less than 10 dB. Thus, it is avoided that the signals transmitted by the transmission modules disrupt the electronic equipment and the other sensors of the aircraft.

Alternatively or additionally, the on-board system comprises a plurality of relays each associated with a group of impact sensors to receive the detection data transmitted by each of the impact sensors of this group, each relay being connected by wire to the computer to transmit said data to the computer.

Advantageously, the detection module is arranged under the fuselage of the aircraft.

In one embodiment of the invention, the detection module comprises at least two cameras each having a different field of view from each other, and a computing unit able to detect the presence of a vehicle in said images acquired by said cameras and to determine the speed of said detected vehicle. If necessary, the fields of view of the two cameras can partially overlap. For example, the positions of said vehicle at a given instant can be estimated from two images acquired at said instant by each of the cameras, in particular by stereoscopy, and the speed of said vehicle can be estimated from the position of said vehicle estimated at two distinct instants, for example by integrating the position of said vehicle over time.

In another embodiment of the invention, the detection module comprises a camera, a computing unit able to detect the presence of a vehicle in an image acquired by the camera, and a telemetry device able to estimate the distance separating it from a vehicle detected by the computing unit, the computing unit being arranged to determine the speed of said detected vehicle based on said estimated distance. For example, the computing unit can be arranged to determine the speed of said detected vehicle by integrating the estimated distance over time. The telemetry device advantageously comprises a transmitter capable of transmitting a signal, a sensor able to receive said signal after reflecting against said detected vehicle, and a computer arranged to estimate the time separating the instant when said signal was transmitted by the transmitter and the instant when said signal was transmitted by the receiver and to estimate said distance based on this estimated time. The telemetry device may for example comprise a LIDAR (“laser imaging detection and ranging”), a RADAR (“radio detection and ranging”), a SONAR (“sound navigation and ranging”) or a time-of-flight sensor.

Advantageously, the detection module comprises four cameras arranged so that the detection module has a field of view of 360°, each camera having for example a field of view of at least 90°.

Preferably, the computing unit can be arranged to implement one or more image processing algorithms to detect the presence of a vehicle in an image acquired by a camera.

Advantageously, the computer is arranged to, during the detection of an impact on the fuselage by one of said impact sensors, record in said memory of the on-board system an image, acquired by the detection module, of a vehicle detected by the detection module in the vicinity of the position of said impact sensor.

In one embodiment of the invention, the on-board system comprises a light system and the computer is arranged to, during the detection by the detection module of a vehicle, the speed of which is greater than a predetermined threshold, control the transmission of a light-up alert by said light system. The on-board system thus makes it possible to warn the driver of a vehicle of its proximity to the aircraft and the risk of collision, due to its speed, between this vehicle and the aircraft.

Advantageously, the light system comprises at least a plurality of light sources, at least one of the light sources being arranged in the vicinity of each sensor. If necessary, the computer is arranged to, during the detection by the detection module of a vehicle whose speed is greater than a predetermined threshold, control the activation of at least one of said light sources capable of transmitting a light beam in the direction where the vehicle is detected. For example, at least one light source can be arranged in the adhesive tape to which one of the impact sensors is attached.

The invention also relates to a method for detecting impacts on the fuselage of an aircraft, the method comprising the following steps:
a. Detecting an impact on the fuselage of an aircraft, by an impact sensor arranged on the fuselage of the aircraft;
b. Detecting a vehicle in the vicinity of the aircraft and estimating the speed of said detected vehicle, by an on-board detection module on the aircraft, and
c. Recording, when an impact on the fuselage is detected by an impact sensor, an item of information relating to the speed of a vehicle detected by the detection module.

Preferably, the method is implemented by an on-board system according to the invention.

The present invention is now described with the aid of examples that are purely illustrative and in no way limiting on the scope of the invention, and based on the attached drawings, in which the various figures show:

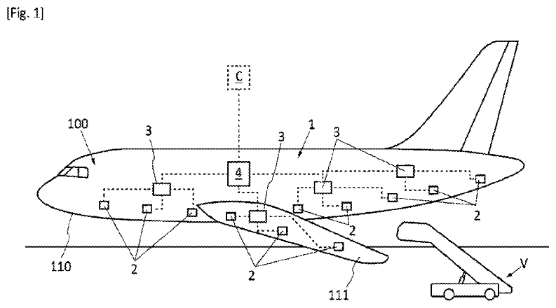

FIG. 1 schematically and partially shows a side view of an aircraft equipped with an on-board system according to one embodiment of the invention;

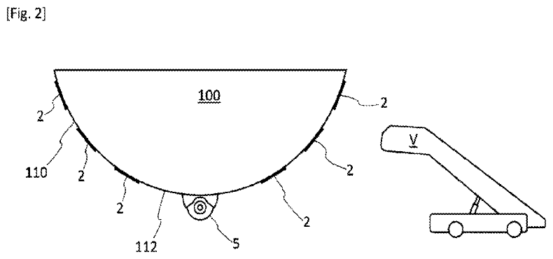

FIG. 2 schematically and partially shows a sectional view of the aircraft of FIG. 1;

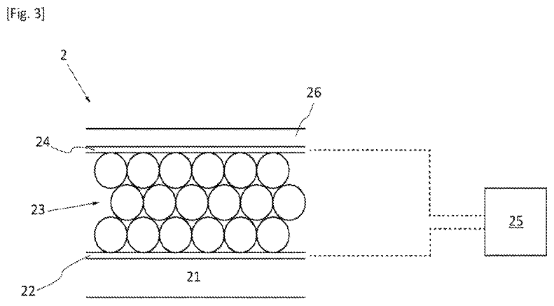

FIG. 3 schematically and partially shows an example impact sensor used in an on-board system according to one embodiment of the invention; and

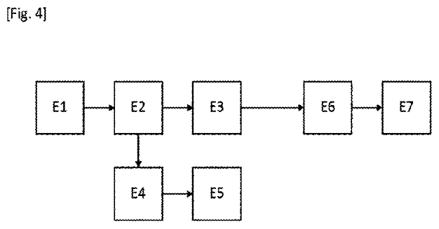

FIG. 4 schematically and partially shows an example method for detecting impacts on the fuselage of an aircraft according to one embodiment of the invention.

In the following description, identical elements, by structure or function, appearing in different figures retain, unless otherwise specified, the same references.

[FIG. 1] shows a side view of an aircraft 100 comprising a fuselage 110. [FIG. 2] shows a cross-sectional view of the aircraft 100, and more precisely of a lower part of the fuselage 110. The aircraft 100 is parked at an airport and a vehicle V, for example intended for transshipping baggage, is travelling near the aircraft 100.

In order to be able to detect an impact of the vehicle V on the fairing 110, and to identify the cause of this impact, the aircraft 100 is equipped with an on-board system for detecting impacts 1 on the fuselage 110.

The on-board system 1 comprises a plurality of impact sensors 2, arranged on the fuselage 110.

FIG. 3 shows an example of an impact sensor 2 used in the on-board system 1 of [FIG. 1] and [FIG. 2].

The impact sensor 2 comprises an electrically insulating substrate 21, to which a first electrode 22 is connected. An assembly of nanoparticles 23 is deposited on the first electrode 22. This assembly 23 comprises a plurality of electrically conductive or semi-conductive nanoparticles, organized in one or more layers, said nanoparticles being bonded together by an electrically resistant ligand. The nanoparticles are deposited on the first electrode 22 in the form of a colloidal suspension, in water or in toluene. A second electrode 24 covers the assembly of nanoparticles 23. Measuring means 25 make it possible to measure the variation of an electrical property between this first electrode 22 and this second electrode 23.

The ligand is advantageously selected from compounds comprising functions capable of chemically binding with the nanoparticles. As non-limiting examples, these may be citrate, amine, phosphine or thiol functions.

The dimension of the assembled nanoparticles 23 is between 2 nanometers and 1 picometers so that the thickness of the assembly 23 of nanoparticles, measured between the two electrodes, is between 2 nanometers and 100 micrometers depending on the dimensions of the nanoparticles and the number of layers deposited. The nanoparticles are for example gold nanoparticles.

The assembly comprising the first electrode 22, the assembly of nanoparticles 23 and the second electrode 24 is advantageously covered with an insulating film 26. When a force substantially normal to the surface of the second electrode 24 is applied to this assembly, the latter displaces the nanoparticles and modifies the distance between them within said assembly 23. As soon as an electrical property is sensitive to the distance between said nanoparticles, the measurement of this property using appropriate means between the two electrodes 22 and 24 delivers information proportional to the deformation of the assembly 23 of nanoparticles under the effect of the stress. The substrate 21 may equally be rigid or flexible, the assembly of nanoparticles 23 constituting the sensing body of this impact sensor 2.

The electrical property sensitive to the distance between the nanoparticles of the assembly 23 is for example the electrical resistivity of said assembly 23, measurable by the measuring means 25. In one variant, it is possible to measure the capacitance variation of said assembly 23. To this end, the conductive nanoparticles are bound by a ligand having a high electrical resistivity. Each pair of nanoparticles separated by said ligand forms a nano-capacitor, the capacity of which is in particular a function of the distance between the conductive nanoparticles. The capacitance variation between the electrodes 22 and 24 is defined by the series/parallel setting of all the capacitances between the nanoparticles of the assembly 23. The measurement means 25 then comprise a resonant circuit produced by coupling an inductor in parallel with the assembly of nanoparticles 23, its resonance frequency thus depending on the capacitance of the assembly of nanoparticles 23, which varies depending on the stresses to which said assembly is subjected. Thus, by measuring the resonance frequency of such a circuit subjected to electromagnetic excitation, it is possible to determine the capacitance variation of said assembly 23.

Each sensor 2 is arranged on an exterior wall of the fuselage 110, for example by being attached or integrated into an adhesive tape bonded to the exterior wall of the fuselage 110. Each sensor 2 can thus detect an impact on the exterior wall of the fuselage 110 and estimate the power of this impact, by measuring the variation of said electrical property which is therefore a function of this impact power. If desired, each sensor 2 may comprise a unit for processing the measurements of the variation of said electrical property carried out by the measuring means 25 and arranged to transmit impact detection data when said measurement exceeds a given threshold, to estimate said impact power from said measurement and to transmit impact power estimation data.

Each sensor 2 is also connected to a wireless transmission module 3 able to transmit said impact detection data and impact power estimate data transmitted by this sensor 2. More specifically, the on-board system 1 comprises a plurality of wireless transmission modules 3, each connected to a group of impact sensors 2 to receive the impact detection data and impact power estimate data transmitted by each sensor 2 of this group. The connection between the sensors 2 of a group and the wireless transmission module connected to this group can be a wired link, produced by a set of cables, or a wireless link.

The on-board system also comprises a computer 4 intended in particular to receive said impact detection data and impact power estimate data relayed by the wireless transmission modules 3. For this purpose, the computer 4 comprises a wireless reception module associated with the various wireless transmission modules 3. It will be noted that each wireless transmission module 3 comprises an antenna whose maximum transmission power is at most 10 dB. Furthermore, the computer 4 is also equipped with a wireless transmission module capable of transmitting data to an external electronic device C.

The sensors 2 are distributed in different areas of the fuselage 110 in order to be able to locate with sufficient accuracy the area of the impact. For example, each sensor 2 has a predetermined identifier specific to it, which is transmitted with said impact detection data and impact power estimate data transmitted by this sensor 2. The set of identifiers is stored in a memory of the computer, which can thus identify the sensor 2 responsible for transmitting the data it receives and therefore to locate the impact on the fuselage 110.

It will be noted that other sensors 2 can be arranged on areas of the aircraft distinct from the fuselage 110, for example on wings 111 as shown in [FIG. 1], the nacelle, the empennage, or even the windows of the aircraft.

Furthermore, the on-board system 1 comprises a module 5 for detecting a vehicle V travelling in the vicinity of the aircraft 100.

In the example described, the detection module 5 is arranged under the fuselage 110, for example at a lower or belly fairing 112. Provision could also be made for arranging the detection module 5 in other locations of the aircraft, at a fairing of the cockpit, wings 111 or landing gear of the aircraft. Provision could also be made to separate the detection module 5 into several sub-modules arranged at different locations of the aircraft.

The detection module 5 comprises a plurality of cameras, forming a sensor able to acquire 360° images of the environment of the aircraft 100. These cameras are associated with a computing unit implementing various algorithms for processing the images acquired by these cameras in order to detect the vehicle V. The detection module 5 also comprises a LIDAR able to estimate the speed of the vehicle V detected by the computing unit, as well as the trajectory of this vehicle V and its direction of movement. Finally, the detection module 5 comprises a wireless transmission module able to transmit, to the wireless reception module of the computer 4, the images acquired by the cameras wherein the vehicle V has been detected by the computing unit as well as its speed, its trajectory and its direction of movement estimated by the LIDAR.

In connection with [FIG. 4], an example of a method for detecting impacts on the fuselage 110 of the aircraft 100 is described below, implemented by means of the on-board system.

In this example, the vehicle V has just collided with the fuselage 110 of the aircraft 100 and is now moving away in a direction away from the aircraft 100.

In a first step E1, the impact is detected by one of the impact sensors 2, which then transmits impact detection data and impact power estimate data to the wireless transmission module 3 to which it is connected, which relays these data to the computer 4.

On receiving the data, in a step E2, the computer 4 triggers the detection of a vehicle V by the detection module 5. In a step E3, the detection module 5 estimates the speed and the trajectory of the vehicle V. The detection of the vehicle V being subsequent to the impact, the detection module 5 therefore estimates that the vehicle V is moving away from the aircraft 100.

At the end of step E3, the image(s) acquired by the cameras of the detection module 5, wherein the vehicle V has been detected, as well as the speed and the trajectory of this vehicle V, are transmitted to the computer 4.

Simultaneously with steps E2 and E3, in a step E4, the computer 4 compares the impact power transmitted by the sensor 2 to a predetermined threshold. If the impact power is greater than said threshold, the impact is likely to have damaged the fuselage 110 of the aircraft 100, which requires maintenance or repair.

In a step E5, an alarm signal is thus transmitted, by the wireless communication module of the computer 4, to the electronic device C, which may for example be a computer terminal of a processing center of the airline operating the aircraft. This is therefore informed in real time of the damage to the fuselage 110 and can therefore react immediately. It should be noted that the alarm signal comprises the location of the impact, determined by means of the identifier of the sensor 2 that detected this impact, which makes it possible to optimize the duration of the maintenance or repair and therefore to reduce the time during which the aircraft 100 is unavailable.

Finally, in order to be able to be able to get the company operating the vehicle V involved and/or to charge it for the cost of the maintenance or repair, the images of the vehicle V, its speed and its trajectory, as well as the location of the impact, its power and its detection time are recorded, in a step E6, by the computer 4 in its memory.

At the end of an operating period of the aircraft 100, all of the impact data stored in the memory of the computer 4 can then be transmitted, in a step E7, to the airline operating that aircraft 100, in the form of a report.

In another embodiment of an impact detection method that can be implemented by the on-board system 1, it could be provided that it is the detection, by the detection module 5, of a vehicle V traveling around the aircraft 100 with a speed greater than a predetermined threshold, which causes the computer 4 to wake up the impact sensors 2.

In this embodiment, it could be envisaged that the speed of the vehicle V, estimated at an instant preceding that of the detection of an impact by a sensor 2, is recorded in the memory of the computer 4.

Furthermore, the on-board system 1 could comprise a plurality of light sources, each arranged in line with each sensor 2, for example by being integrated into the adhesive tape to which each sensor 2 is attached. In this case, when the speed of the vehicle V estimated by the detection module 5 is greater than said predetermined threshold, the computer 4 can be able to control the transmission of light by at least one of these light sources, in particular by a light source capable of transmitting a light beam in the direction of said vehicle V.

In yet another embodiment of an impact detection method that can be implemented by the on-board system 1, provision could be made for the detection module 5 to permanently monitor the surroundings of the aircraft 100 and for all of the sensors 2 to be in a state of active impact detection.

The foregoing description clearly explains how the invention makes it possible to achieve the objectives that it has set, and in particular by proposing an on-board system on an aircraft, combining a plurality of impact sensors on the fuselage of that aircraft and a module for detecting a vehicle around the aircraft and capable of estimating the speed of a detected vehicle, the system thus enabling the airline operating the aircraft to identify the vehicle responsible for damage to the fuselage and to verify the causes of this damage.

In any case, the invention is not limited to the embodiments specifically described in this document, and extends in particular to any equivalent means and to any technically operative combination of these means. In particular, other types of sensor can be envisaged than those described, and in particular piezoelectric, piezoresistive or even capacitive sensors. It is also possible to envisage other types of detection modules than the one described, and in particular a detection module employing only cameras, with the speed of a detected vehicle being estimated by stereography.

1-13. (canceled)

14. An on-board system for detecting impacts on the fuselage of an aircraft, comprising:
a plurality of impact sensors arranged on a plurality of areas of the fuselage, each sensor being able to detect an impact on the fuselage at its position;
a module for detecting a vehicle in the vicinity of the aircraft, the detection module being able to estimate the speed of a detected vehicle; and,
a computer arranged to, when an impact on the fuselage is detected by an impact sensor, record information in a memory of the on-board system, relating to the speed of a vehicle detected by the detection module.

15. The system according to claim 14, wherein the computer is arranged to, when an impact on the fuselage is detected by an impact sensor, trigger the detection of a vehicle in the vicinity of the aircraft by the detection module and the estimating of the speed of said detected vehicle.

16. The system according to claim 15, wherein each impact sensor is a piezoelectric sensor, of the piezoresistive or capacitive type.

17. The system according to claim 16, wherein each sensor comprises:
a sensing body;
an electrically insulating substrate;
a first electrode bonded to the substrate;
a second electrode;
a set of conductive or semi-conductive nanoparticles in contact with the two electrodes; and,
a measurement device delivering information proportionate to an electrical property of the set of nanoparticles, which property is measured between the first and second electrodes, said electrical property being sensitive to the distance between the nanoparticles of the assembly, such that the sensing body is formed by the assembly of nanoparticles itself.

18. The system according to claim 14, wherein the impact sensors are arranged on an exterior wall of the fuselage.

19. The system according to claim 18, wherein each impact sensor is attached to an adhesive tape bonded to the exterior wall of the fuselage.

20. The system according to claim 14, wherein each impact sensor is connected to a wireless transmission module capable of transmitting data relating to a detection carried out by said impact sensor, and wherein the computer comprises a wireless reception module for receiving said data.

21. The system according to claim 14, wherein the detection module is arranged under the fuselage of the aircraft.

22. The system according to claim 14, wherein the detection module comprises at least two cameras each having a different field of view from each other, and a computing unit able to detect the presence of a vehicle in said images acquired by said cameras and to determine the speed of said detected vehicle.

23. The system according to claim 14, wherein the detection module comprises:
a camera;
a computing unit able to detect the presence of a vehicle in an image acquired by the camera; and,
a telemetry device able to estimate the distance separating it from a vehicle detected by the computing unit, the computing unit being arranged to determine the speed of said detected vehicle based on said estimated distance.

24. The system according to claim 14, wherein the detection of an impact on the fuselage by one of said impact sensors, record in said memory of the on-board system an image, acquired by the detection module, of a vehicle detected by the detection module in the vicinity of the position of said impact sensor.

25. The system according to claim 14, wherein it comprises a light system and the computer is arranged to, during the detection by the detection module of a vehicle, the speed of which is greater than a predetermined threshold, control the transmission of a light-up alert by said light system.

26. The system according to claim 25, wherein the light system comprises at least a plurality of light sources, at least one of the light sources being arranged in the vicinity of each sensor, and wherein the computer is arranged to, during the detection by the detection module of a vehicle whose speed is greater than a predetermined threshold, control the activation of at least one of said light sources capable of transmitting a light beam in the direction where the vehicle is detected.
